(19) United States
(12) Patent Application Publication
(10) Pub. No.: US 2005/0214183 A1
(43) Pub. Date: Sep. 29, 2005

(54) Heat sink and ozone generator arrangement

(76) Inventor: Liang Chung Yen, Pan Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,574

(22) Filed: May 11, 2004

(30) Foreign Application Priority Data
Mar. 23, 2004 (TW) 093204374

(51) Int. Cl. B01J 19/08

(52) U.S. Cl. 422/186.07

(57) ABSTRACT

A heat sink and ozone generator arrangement includes an ozone generator, which has a center tube and a rod electrode mounted in the center tube and defining with the center tube an annular air gap for the production of ozone upon presence of air and a corona discharge in the annular air gap, and a heat sink mounted on the periphery of the center tube and adapted to dissipate heat from the ozone generator.

### BACKGROUND OF THE INVENTION

1. Field of the Invention

The present invention relates to an ozone generating apparatus and more particularly, to a heat sink and ozone generator arrangement, which effectively dissipates heat from the ozone generator during working of the ozone generator, thereby improving the quality of generated ozone.

2. Description of the Related Art

Ozone can be used to sterilize water, packing water, pharmaceutical/food grade cleaning water, etc., to purify air, to oxidize organic substances that are not biodegradable, or to bleach cosmetic grade kaolinite. Further, during a water therapy, for example, SPA, ozone may be used as a water therapy medium because ozone can decompose dirt and waste matter in capillaries on the skin to improve breathing of the skin when dissolved in water.

Various ultraviolet ozone generators, electrolytic ozone generators and corona discharge ozone generators have been disclosed, and have appeared on the market. During working of an ozone generator, the temperature of the ozone generator gradually increases and may reaches a high level up to 80˜150° C. When surpassed 30° C., the concentration of ozone starts to drop. Therefore, the desired high concentration of ozone is not possible if the temperature of the ozone generator surpassed a high level.

Therefore, it is desirable to provide an ozone generator, which has means to dissipate heat, keeping the ozone generator in the optimum working temperature level.

### SUMMARY OF THE INVENTION

The present invention has been accomplished under the circumstances in view. It is one object of the present invention to provide a heat sink and ozone generator arrangement, which quickly dissipates heat from the ozone generator during working of the ozone generator, keeping the ozone generator to function normally. It is another object of the present invention to provide a heat sink and ozone generator arrangement, which improves the functioning of the ozone generator, thereby maintaining the concentration of generated ozone within the optimum range.

To achieve these and other objects of the present invention, the heat sink and ozone generator arrangement comprises an ozone generator adapted to generate ozone, the ozone generator comprising a center electrode assembly and a center tube, the center electrode assembly comprising a rod electrode mounted in the center tube for producing a corona discharge, the rod electrode defining with the center tube an annular air gap for the production of ozone upon presence of air and a corona discharge in the annular air gap; and a heat sink mounted on the periphery of the center tube and adapted to dissipate heat from the ozone generator, the heat sink comprising a plurality of radiation fins for dissipation of heat.

### BRIEF DESCRIPTION OF THE DRAWINGS

FIG. 1 is an elevational assembly view of a heat sink and ozone generator arrangement according to the first embodiment of the present invention.

FIG. 2 is an exploded view of the heat sink and ozone generator arrangement according to the first embodiment of the present invention.

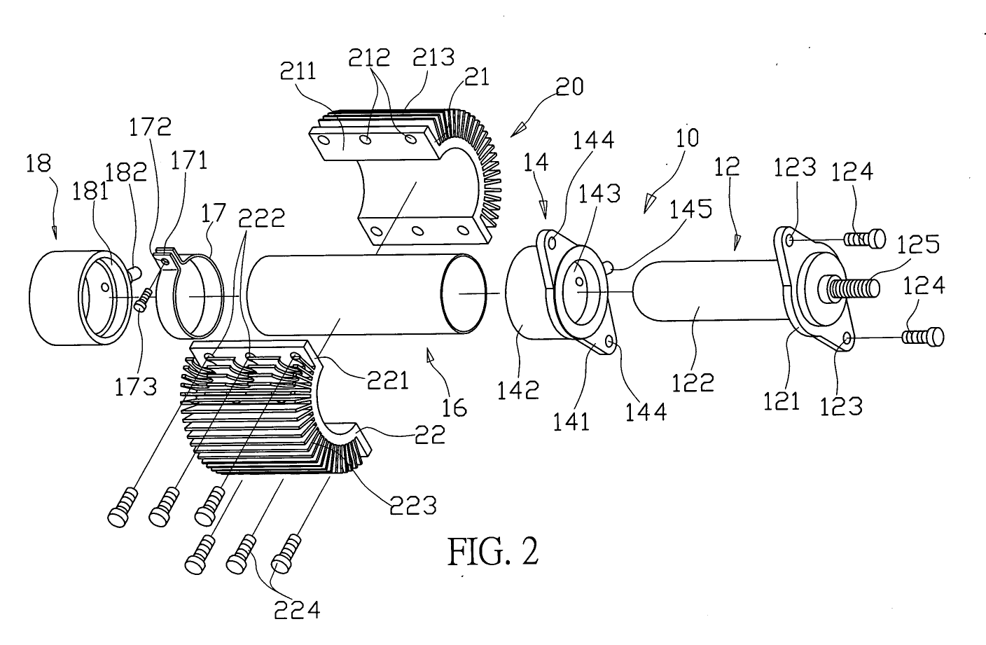

FIG. 3 is a sectional elevation of the heat sink and ozone generator arrangement according to the first embodiment of the present invention.

FIG. 4 is an elevational assembly view of a heat sink and ozone generator arrangement according to the second embodiment of the present invention.

### DETAILED DESCRIPTION OF THE PREFERRED EMBODIMENT

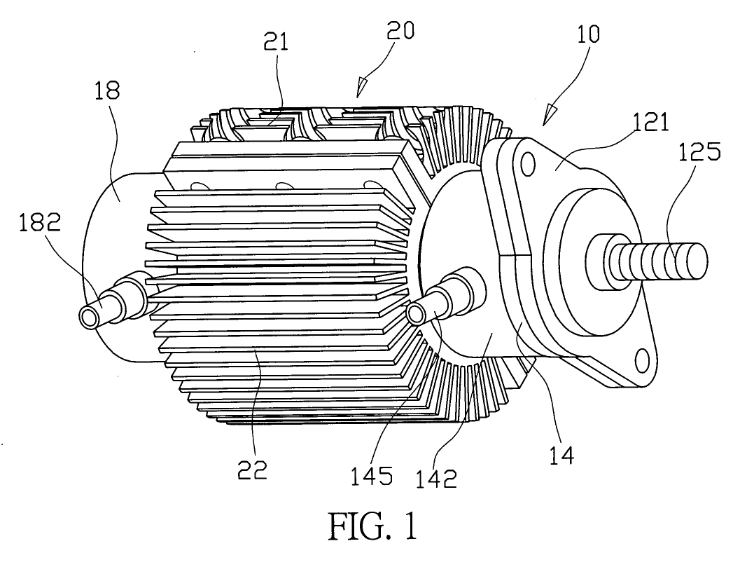

Referring to FIGS. 1˜3, a heat sink and ozone generator arrangement in accordance with the present invention is shown comprised of an ozone generator 10 and a heat sink 20.

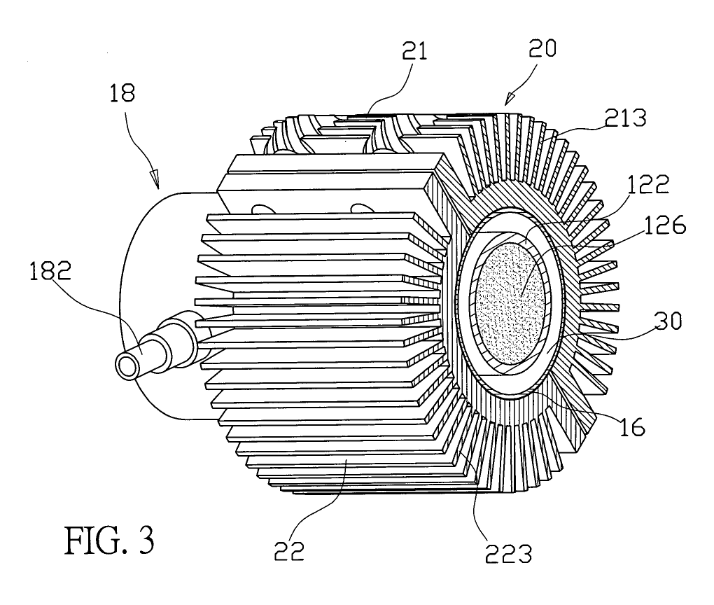

The ozone generator 10 comprises a center electrode assembly 12, a first end connector 14, a center tube 16, a grounding electrode 17, and a second end connector 18. The center electrode assembly 12 comprises an end plate 121 and a rod electrode 122. The end plate 121 comprises a plurality of mounting holes 123 and a high-voltage electrode 125. The high-voltage electrode 125 is connected to a power cord (not shown). The rod electrode 122 is a quartz glass tube stuffed with alumina 126 (see FIG. 3), which is electrically connected to the high-voltage electrode 125, forming the charge-discharging terminal of the center electrode assembly 12. The first end connector 14 is an electrically insulative member comprising a barrel-like connector body 142, a mounting plate 141 extended around the periphery of one end of the connector body 142, an axial hole 143 axially extended through the mounting plate 141 and the barrel-like connector body 142 for receiving the rod electrode 122 of the center electrode assembly 12, an air inlet tube 145 perpendicularly extended from the periphery of the barrel-like connector body 142 in air-communication with the axial hole 143, and a plurality of mounting holes 144 formed in the mounting plate 141 and respectively connected to the mounting holes 123 of the end plate 121 of the center electrode assembly 12 with screws 124.

The center tube 16 is a metal tube connected between the first end connector 14 and the second end connector 18 to accommodate the rod electrode 122 of the center electrode assembly 12. The center tube 16 defines with the rod electrode 122 of the center electrode assembly 12 an annular air gap 30 (see FIG. 3).

The grounding electrode 17 is formed of a metal clamp clamped on the periphery of the center tube 16, having two distal ends respectively terminating in a respective end lug 171. The two end lugs 171 of the grounding electrode 17 each have a mounting hole 172. A screw 173 is mounted in the mounting holes 172 of the two end lugs 171 to secure the grounding electrode 17 to the periphery of the center tube 16.

The second end connector 18 comprises a receiving open chamber 181, which receives one end of the center tube 16, and an air outlet tube 182 perpendicularly extended from the periphery thereof in air-communication with the annular air gap 30. Therefore, the air inlet tube 145 forms with the annular air gap 30 and the air outlet tube 182 an air passage.

The heat sink 20 is comprised of a first heat sink member 21 and a second heat sink member 22. The first heat sink member 21 and the second heat sink member 22 are shaped like a semicircular tube, each comprising two mounting flanges 211 or 221 symmetrically disposed at two sides, a plurality of mounting holes 212 or 222 symmetrically formed in the mounting flanges 211 or 221, and a plurality of radially extended radiation fins 213 or 223. Screws 224 are fastened to the mounting holes 222 in the mounting flanges 221 of the second heat sink member 22 and the mounting holes 212 of the mounting flanges 211 of the first heat sink member 21 to secure the first heat sink member 21 and the second heat sink member 22 to the periphery of the center tube 16. Further, an electric fan (not shown) may be used to cause currents of air toward the radiation fins 213, 223 of the first heat sink member 21 and second heat sink member 22 of the heat sink 20.

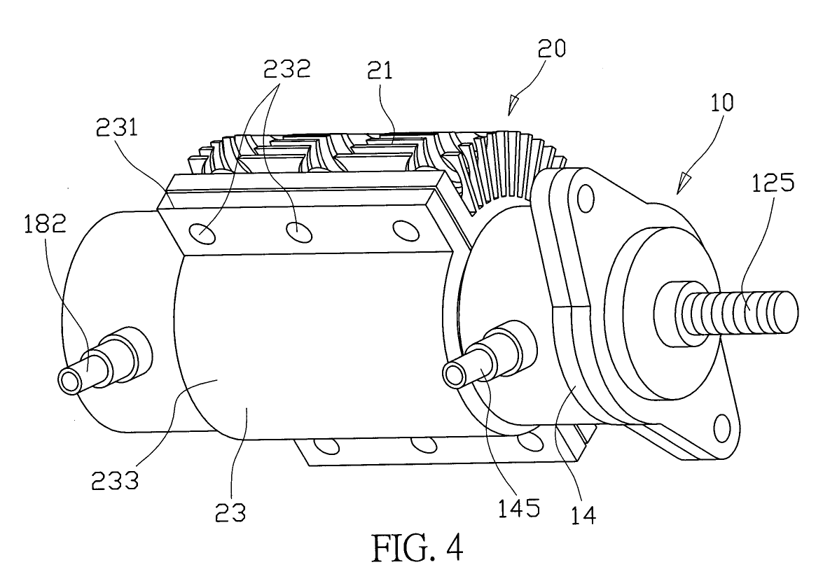

FIG. 4 shows an alternate form of the present invention. According to this embodiment, the heat sink 20 is comprised of a first heat sink member 21 and a second heat sink member 22. The first heat sink member 21 and the second heat sink member 22 are shaped like a semicircular tube. The first heat sink member 21 and the second heat sink member 22 each comprise two mounting flanges 231 and a plurality of mounting holes 232 symmetrically formed in the mounting flanges 231. The second heat sink member 22 is a smoothly arched plate member having a smooth outer surface without radiation fins.

After connection of electricity to the ozone generator 10, a corona discharge is produced in the annular air gap 30 between the center tube 16 and the rod electrode 122 of the center electrode assembly 12. At the same time, a flow of air is delivered through the air passage, which is formed of the air inlet tube 145, the annular air gap 30, and the air outlet tube 182. When air is passing through the corona discharge area, oxygen molecule bonds are broken, thereby producing monoatomic oxygen that is bonded with other oxygen molecules to form triatomic oxygen, i.e., the so-called ozone. Triatomic oxygen thus produced passes out of the ozone generator 10 through the air outlet tube 182. During the aforesaid corona discharge, a big amount of heat is produced and transferred through the center tube 16 to the heat sink 20 where the radiation fins 213 and 223 of the first heat sink member 21 and second heat sink member 22 of the heat sink 20 dissipate heat into the open air, and therefore the concentration of the ozone generated by the ozone generator 10 is maintained within the expected range.

A prototype of heat sink and ozone generator arrangement has been constructed with the features of FIGS. 1˜4. The heat sink and ozone generator arrangement functions smoothly to provide all of the features discussed earlier.

Although particular embodiments of the invention have been described in detail for purposes of illustration, various modifications and enhancements may be made without departing from the spirit and scope of the invention.

1. A heat sink and ozone generator arrangement comprising:
an ozone generator adapted to generate ozone, said ozone generator comprising a center electrode assembly and a center tube, said center electrode assembly comprising a rod electrode mounted in said center tube for producing a corona discharge, said rod electrode defining with said center tube an annular air gap for the production of ozone upon presence of air and a corona discharge in said annular air gap; and
a heat sink mounted on the periphery of said center tube and adapted to dissipate heat from said ozone generator, said heat sink comprising a plurality of radiation fins for dissipation of heat.

2. The heat sink and ozone generator arrangement as claimed in claim 1, wherein said center electrode assembly further comprises an end plate, said end plate comprising a high-voltage electrode electrically connected to said rod electrode.

3. The heat sink and ozone generator arrangement as claimed in claim 1, wherein said rod electrode is comprised of a heat-resisting glass tube.

4. The heat sink and ozone generator arrangement as claimed in claim 3, wherein said heat-resisting glass tube of said rod electrode is stuffed with alumina.

5. The heat sink and ozone generator arrangement as claimed in claim 2, wherein said rod electrode is stuffed with alumina, which is electrically connected to said high-voltage electrode.

6. The heat sink and ozone generator arrangement as claimed in claim 1, wherein said ozone generator further comprises an electrically insulative first end connector and second end connector respectively mounted on said rod electrode of said center electrode assembly and fastened to two distal ends of said center tube, an air inlet tube connected to said first end connector and adapted to guide air into said annular air gap, and an air outlet tube connected to said second end connector and adapted to guide ozone out of said annular air gap.

7. The heat sink and ozone generator arrangement as claimed in claim 1, wherein said ozone generator further comprises a grounding electrode formed of a metal clamp and fastened to the periphery of said center tube.

8. The heat sink and ozone generator arrangement as claimed in claim 1, wherein said heat sink is comprised of a first heat sink member and a second heat sink member, said first heat sink member and said second heat sink member being abutted against each other around the periphery of said center tube; said radiation fins are respectively radially extended from said first heat sink member and said second heat sink member.

9. The heat sink and ozone generator arrangement as claimed in claim 1, wherein said heat sink is mounted with electric fan means adapted to cause currents of air toward said radiation fins.
